(19) United States
(12) Patent Application Publication
(10) Pub. No.: US 2007/0210152 A1
(43) Pub. Date: Sep. 13, 2007

(54) Method and System for Linking Additional Value to a Stored Value or Gift Card

(76) Inventor: John K. Read, Glenview, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/608,403

(22) Filed: Dec. 8, 2006

Related U.S. Application Data
(60) Provisional application No. 60/749,149, filed on Dec. 8, 2005.

(51) Int. Cl. G06K 5/00; G06Q 40/00

(52) U.S. Cl. 235/380; 705/39

(57) ABSTRACT

In a system that utilizes a stored value or gift card (SVGC), additional value is linked to the SVGC. This additional value may provide an added incentive for purchasing the SVGC. The additional value may be a product or service, for example. The additional value may be linked to certain actions associated with the SVGC. For example, a customer may be given access to the additional value upon activation of the SVGC, upon the purchase of a particular product, upon the purchase of a product from a particular group of products, upon using the SVGC to purchase during a particular time period, upon adding value to the SVGC, etc.

### CROSS-REFERENCES TO RELATED APPLICATIONS

The present application claims the benefit of U.S. Provisional Application No. 60/749,149, entitled “METHOD AND SYSTEM FOR LINKING ADDITIONAL VALUE TO A STORED VALUE OR GIFT CARD,” filed on Dec. 8, 2005, which is hereby incorporated by reference herein in its entirety.

### BACKGROUND

Stores, gas stations, etc., often sell Stored Value or Gift Cards (SVGC's) typically good for a certain amount of pre-paid value. Cards can be either closed-loop cards, good only in one or a small group of retail locations, or a group of stores owned by an umbrella entity. These multiple retail locations or groups of retail locations stores are often linked together by a network computer, satellite or some other type system. The activation, usage, remaining balance and most or all of the financial activity of the card is either calculated and stored on the Retailer's computer system or are outsourced to an outside stored value card processor, such as Stored Value Systems, Inc. which can also hold the money on the gift card for the merchant. A third type of SVGC is the Visa, MasterCard or American Express Gift Cards, which are non-reloadable and sold only in certain denominations and can be used anywhere those vendors' cards are accepted.

SVGC's are primarily activated by a POS (Point-of-Sale) system, in which the individual purchased card may be swiped through a POS device that is usually the same device used to swipe credit or debit cards. Also, a bar code on the SVGC may be scanned by a bar code reader. Once the individual purchased card is swiped or scanned, that particular number and the dollar value that is to be assigned or loaded to the SVGC is sent to a host computer of the retail merchant via a network. The card number and amount assigned/loaded is either then processed and stored on the retailer's computer system or sent via a modem, satellite, etc. to an outside stored value card processor. At times this transmission can be routed to the outside stored value card processor from the store level, without going to the retailer's host computer system. Each time after purchase and activation the card is used, the same transmission process takes place to the party holding and/or calculating the cards value, authorizing or declining the purchase or purchases until the cards value is used up or the card is reloaded with additional value.

Certain SVGC's are now being sold not only in the retailer's location, but in third party's locations such as another retailer's stores. An additional link may be made to the party who services that individual retailer's cards for the activation process. Other SVGC's can be given away as part of a promotion or offered on-line for certain activity on-line.

Sales of SVGC's are growing yearly, yet they sell primarily in the pre-Christmas shopping season. Retailers are looking for ways to increase their SVGC sales especially during non-holiday times of the year.

### BRIEF DESCRIPTION OF THE DRAWINGS

FIG. 1 is a block diagram of an example system that may utilize an SVGC to which additional value may be linked; and

FIG. 2 is a flow diagram of an example method for utilizing an SVGC linked to an additional value.

### DETAILED DESCRIPTION

In a system that utilizes a stored value or gift card (SVGC), additional value is linked to the SVGC. This additional value may provide an added incentive for purchasing the SVGC. The additional value may be a product or service, for example. The additional value may be linked to certain actions associated with the SVGC. For example, a customer may be given access to the additional value upon activation of the SVGC, upon the purchase of a particular product, upon the purchase of a product from a particular group of products, upon using the SVGC to purchase during a particular time period, upon adding value to the SVGC, etc.

In one embodiment, a method for utilizing a stored value or gift card (SVGC) may comprise activating the SVGC, the SVGC having an associated purchasing value, and determining whether the SVGC is linked to an added value, the added value in addition to the associated purchasing value and any additional purchasing value that may be associated with the SVGC. The method may also comprise determining whether the added value has been activated if f the SVGC is linked to the added value, and permitting a consumer to redeem the added value if the added value has been activated.

In another embodiment, a method for permitting redemption of added value linked to stored value or gift card (SVGCs) may include storing indications of SVGCs that are linked with respective added values, the added values in addition to any stored purchasing values or gift card purchasing values that are or will be associated with the SVGCs. The method additionally may include activating the linked added values for at least some of the SVGCs. Also, the method may include determining if the respective added value linked to one of the SVGCs is activated based on an indicator of the one SVGC, and permitting a user to redeem the respective added value linked to the one of the SVGCs if the linked added value is activated.

In yet another embodiment, a method for permitting redemption of added value linked to stored value or gift card (SVGCs) may comprise providing SVGCs that are linked with respective added values, the added values in addition to any stored purchasing values or gift card purchasing values that are or will be associated with the SVGCs. The method may also comprise permitting a user to redeem the respective added value linked to the one of the SVGCs if the SVGC is activated and if linked added value is activated.

### Example System

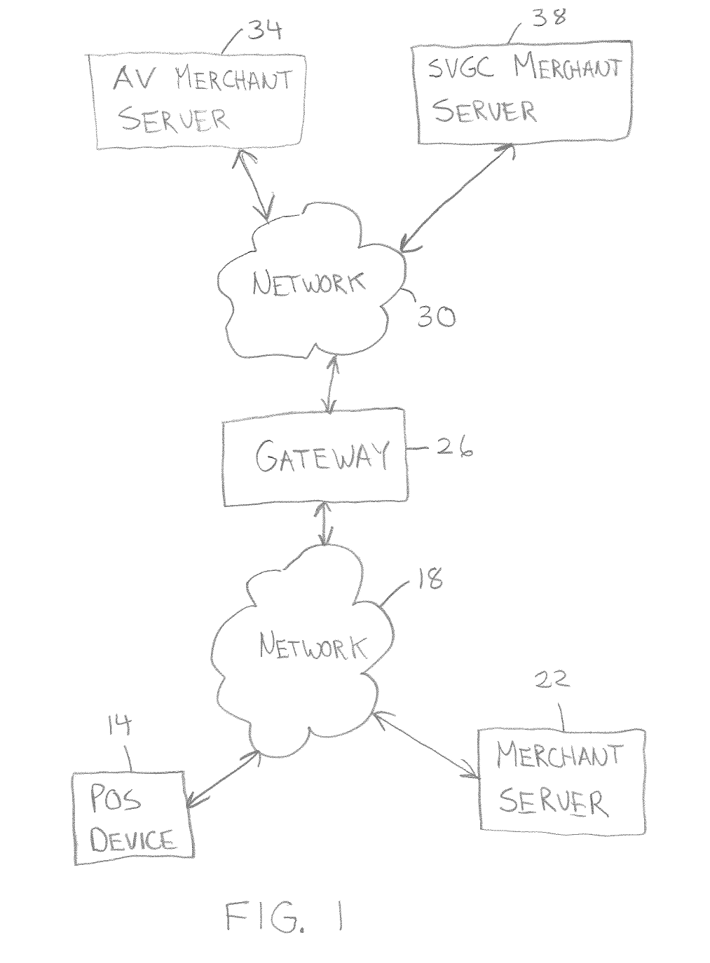

FIG. 1 is a block diagram of an example system 10 that may utilize an SVGC to which additional value may be linked. The system 10 includes a point-of-sale (POS) device 14 communicatively coupled to a communications network 18. The POS device 14 may include, for example, a magnetic scanner, a bar code reader, etc., and may be located in a merchant's store. The network 18 may include, for example, a local area network (LAN), a wide area network (WAN), wired communication links, wireless communication links, etc. The system 10 also may include a merchant server 22 communicatively coupled to the network 18. The merchant server 22 and the POS device 14 may communicate with one another via the network 18. Although only one POS device 14 is illustrated, a merchant may typically utilize a plurality of POS devices 14 in one or more stores. The merchant server 22 may be associated with one store, a plurality of stores having the same name, or an association of differently named stores, for example.

The system 10 may also include a gateway device 26 communicatively coupled between the network 18 and a communications network 30. The communications network 30 may include a LAN, a WAN, the Internet, an intranet, wired communication links, wireless communication links, etc. The system 10 may further include an additional value (AV) merchant server 34 communicatively coupled to the network 30. The AV merchant server 34 may be associated with a merchant or association that provides an additional value, such as a product or service, associated with an SVGC card.

Still further, the system 10 may include an SVGC merchant server 38 communicatively coupled to the network 30. The SVGC merchant server 38 may be associated with a merchant or association that administers SVGC cards. Thus, the merchant that administers SVGC cards may be different from the merchant associated with the POS device 14.

In some implementations, one or more of the merchant server 22, the AV server 34 and the SVGC merchant server 38 may be omitted. For example, in some implementations, the merchant server 22 could be omitted. As another example, one or both of the AV merchant server 34 and the SVGC merchant server 38 could be omitted. For instance, if the added value is provided by the merchant, the AV merchant server 34 could be omitted and/or its functionality could be implemented by the merchant server 22. Similarly, if a third party SVGC merchant was not utilized, the SVGC merchant server 38 could be omitted and/or its functionality could be implemented by the merchant server 22. When present, the merchant server 22 may communicate with the AV server 34 and/or the SVGC server 38 via the network 18 and the network 30. When present, the AV server 26 may communicate with the SVGC server 38 via the network 30. The POS device 14 may communicate with one or more of the AV server 34 and/or the SVGC server 38 via the network 18 and the network 30.

### Linking to Additional Value

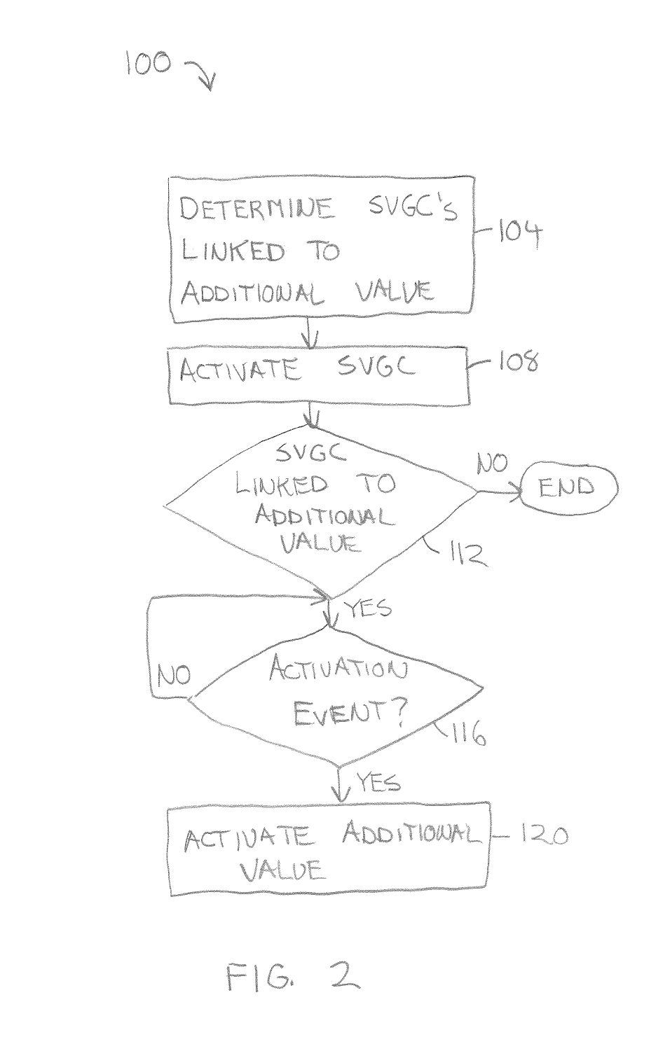

FIG. 2 is a flow diagram of an example method 100 for utilizing an SVGC linked to an additional value. The method 100 may be implemented by a system such as the system 10 of FIG. 1, and the method 100 will be described with reference to FIG. 1. Of course, the method 100 may be implemented by a different system as well, and the system 10 of FIG. 1 may implement different methods. At a block 104, SVGC's that are linked to an additional value may be determined. For example, identifiers of SVGC's linked to the additional value may be stored in a database, communicated to a server of a merchant, communicated to a server of a SVGC merchant, communicated to a server of an additional value merchant. In the system 10, identifiers of SVGC's linked to the additional value may be communicated to one or more of the merchant server 22, the AV server 34, and/or the SVGC server 38.

At a block 108, the SVGC may be activated. The SVGC may be activated in a variety of ways. For example, the SVGC could be preactivated by a provider of the SVGC's. Also, the SVGC could be activated at the POS. For example, the SVGC could be activated by first entering an identifier of the SVGC at the POS device 14. This may include swiping the SVGC through a magnetic reader or scanning a bar code on the SVGC, for example. Then, the POS device 14 could send a request for activation. For example, the request could be sent to the merchant server 22 and/or the SVGC server 38. The request could include the identifier of the SVGC and, optionally, the value of the SVGC. Next, if activated (for example, by the merchant server 22 or the SVGC server 38), the POS device 14 could receive an activation message from, for example, the merchant server 22 and/or the SVGC server 38.

At a block 112, it may be determined if the SVGC is linked to an additional value. For example, the POS device 14, the merchant server 22, the AV server 34, and/or the SVGC server 38 could determine if the SVGC activated at the block 108 is linked to an additional value. This may comprise, for example, reading information stored on the card (i.e., on a magnetic stripe, in a bar code, etc.), examining a database, etc. The block 112 may be implemented at any of variety of times, and may be implemented one or more times. For example, the block 112 may be implemented when the SVGC is activated, when the SVGC is used to make a purchase, etc.

If it is determined that the SVGC is not linked to the additional value, the flow may end. If it is determined that the SVGC is linked to the additional value, the flow may proceed to the block 116. At the block 116, it may be determined if an added value activation event occurred. The added value activation event may comprise any of a variety of events. For example, the added value activation event may comprise activation of the SVGC. In this case, the block 116 optionally may be combined with the block 108 or the block 112 or the block 116 may be omitted. For example, if at block 112 it is determined that the SVGC is linked to the additional value, it may be assumed that the SVGC has been activated and thus that the added value activation event has occurred.

Other examples of added value activation events include the purchase of a particular product, the purchase of a product from a particular group of products, using the SVGC to purchase during a particular time period, adding value to the SVGC, a store clerk or consumer pressing a button at a POS device, a consumer entering the SVGC identifier into a web page, etc. The POS device 14, the merchant server 22, the AV server 34, and/or the SVGC server 38 could determine if the added value activation event occurred. For example, one or more of the POS device 14, the merchant server 22, the AV server 34, and/or the SVGC server 38 could monitor activity associated with the SVGC card and determine whether the added value activation event occurred.

If it is determined that the added value activation event did not occur, the flow may wait until the added value activation event does occur. If it is determined that the added value activation event occurred, the flow may proceed to the block 120. At the block 120, the added value may be activated. For example, if the system includes the AV merchant server 34, the block 120 may comprise sending a notification to the AV merchant server 34 when it has been determined that the added value activation event occurred. Optionally, the AV merchant server 34 could determine whether the added value activation event occurred.

The block 120 may comprise storing an indication that the added value linked to the SVGC is activated. For example, an indication that the added value had been activated could be associated with an identifier of the SVGC in a database of SVGC identifiers. As another example, an identifier of the SVGC could be stored in a database associated with SVGC's with which the added value had been activated. In the system 10 of FIG. 1, the POS device 14, the merchant server 22, the AV merchant server 26, or the SVGC merchant server 38 could store the indication that the added value linked to the SVGC is activated.

Then, when the consumer attempted to redeem the added value, it could be determined whether the added value had been activated using the identifier of the SVGC. For example, the when the consumer attempted to redeem the added value, the identifier of the SVGC could be obtained by swiping it through a magnetic reader, scanning it with a bar code scanner, etc. Next, a database could be queried using the SVGC's identifier to determine if the added value associated with the SVGC had been activated. If the added value associated with the SVGC had been activated, the added value could be permitted to be redeemed.

### EXAMPLES OF ADDITIONAL VALUE LINKED TO SVGC'S

Some example of additional value linked to SVGC's is provided below. One of ordinary skill in the art will recognize that these are merely examples and that many other types of additional value may be utilized as well.

### Example #1

A gas gift card is sold for $50.00. The added value includes one free emergency roadside call for a period of 90 days from when the card is sold. The cardholder is automatically enrolled upon the card's activation or upon sale of the card. The free emergency roadside call response could be provided by a national network of service providers, a regional network of service providers, a particular network provider, etc. The free response could include one or more of a towing service, a battery jump, minor roadside adjustments, flat tire changes, fuel delivery, vehicle extraction, lock-out service, etc.

### Example #2

Once a certain retailer's gift card is purchased, the card's number is automatically entered into a sweepstakes upon activation or sale of the card. The sweepstakes award may be cash, value added to the gift card, a free vacation, etc.

### Example #3:

A gift card for a clothing store is sold. Upon activation or sale, one free ringtone, downloadable song, etc. is linked to that gift card. To redeem, the card purchaser may go online to a redemption web site, enter a card identifier (e.g., a card number) and download a ringtone, a song, etc.

### Example #4

Each time a SVGC is reloaded with at least $25.00, an additional free ringtone or downloadable song is linked to the card.

### Example #5

A gift card for a clothing store is sold. Upon activation or sale, the consumer is eligible for a discount at an association of hotels and/or motels, a chain of hotels and/or motels, a particular hotel or motel, etc.

### Example #6

A gas gift card is sold. Upon activation or sale, the consumer is eligible for a dental, medical, and/or prescription discount at an association of dental and/or medical providers, particular dental and/or medical providers, one or more pharmacies, etc. The card may include a logo or other indicator that the consumer is entitled to the discount. To obtain the discount, the card may be shown to the medical provider, dental provider, or pharmacy. Optionally, the medical provider, dental provider, or pharmacy may verify that the consumer is entitled to the discount by providing a card identifier, consumer name, etc., to a verifying service. Optionally, a website may be provided to help the consumer identify participating medical providers, dental providers, and/or pharmacies.

### Example #7

A retailer gift card is sold. Upon activation or sale, the consumer is eligible for a vision discount at an association of vision service providers and/or vision product providers, particular vision service providers and/or vision product providers, etc. The card may include a logo or other indicator that the consumer is entitled to the discount. To obtain the discount, the card may be shown to the vision service provider and/or vision product provider. Optionally, the vision service providers and/or vision product provider may verify that the consumer is entitled to the discount by providing a card identifier, consumer name, etc., to a verifying service. Optionally, a website may be provided to help the consumer identify participating vision service providers and/or vision product providers.

### Example #8

A gas gift card is sold. Upon activation or sale, the consumer is eligible to use a 24-hour nurse helpline. To use the helpline, the consumer may be asked to provide a card identifier (e.g., a card number), a name, etc.

### Example #9

A retailer gift card is sold. Upon activation or sale, the consumer is eligible for enrollment in a credit builder program. For example, if the consumer makes regular additions of value to the card (e.g., at least 5 dollars every month), these payments can be reported to credit bureaus as monthly on-time payments. This service may help a consumer to begin to build a legal credit profile if the consumer is without any credit history or needs to rebuild bad credit. To credit bureaus, the regularity of payments is typically more important than the size of the payment. Thus, even a $9.95 monthly payment reported over a period of time may help increase a person's credit score. If payments are missed, no negative information is reported to the credit bureaus although an opportunity may be missed to continue building a solid pattern.

### Example #10

A retailer gift card is sold. Upon activation or sale, the consumer is eligible for a legal and/or financial referral plan that provides referrals to attorneys and/or financial professionals. Optionally, the plan may include receiving preferred rates and/or discounts from attorneys' and financial professionals' normal hourly rates. Optionally, the plan may permit one or more free consultations per year.

### Example #11

A gas gift card is sold. Upon activation or sale, the consumer is eligible for access to a coupon web site and/or may purchase a coupon book at a discounted price.

### Example #12

A gas gift card is sold. Upon activation or sale, the consumer is eligible for discounts at an association of retailers, particular retailers, etc.

While the invention is susceptible to various modifications and alternative constructions, certain illustrative embodiments thereof have been shown in the drawings and are described in detail herein. It should be understood, however, that there is no intention to limit the disclosure to the specific forms disclosed.

What is claimed is:

1. A method for utilizing a stored value or gift card (SVGC), comprising:
activating the SVGC, the SVGC having an associated purchasing value;
determining whether the SVGC is linked to an added value, the added value in addition to the associated purchasing value and any additional purchasing value that may be associated with the SVGC;
if the SVGC is linked to the added value, determining whether the added value has been activated; and
if the added value has been activated, permitting a consumer to redeem the added value.

2. A method for permitting redemption of added value linked to stored value or gift card (SVGCs), comprising:
storing indications of SVGCs that are linked with respective added values, the added values in addition to any stored purchasing values or gift card purchasing values that are or will be associated with the SVGCs;
activating the linked added values for at least some of the SVGCs;
determining if the respective added value linked to one of the SVGCs is activated based on an indicator of the one SVGC; and
permitting a user to redeem the respective added value linked to the one of the SVGCs if the linked added value is activated.

3. A method for permitting redemption of added value linked to stored value or gift card (SVGCs), comprising:
providing SVGCs that are linked with respective added values, the added values in addition to any stored purchasing values or gift card purchasing values that are or will be associated with the SVGCs; and
permitting a user to redeem the respective added value linked to the one of the SVGCs if the SVGC is activated and if linked added value is activated.
